(19) United States
(12) Patent Application Publication
(10) Pub. No.: US 2008/0178989 A1
(43) Pub. Date: Jul. 31, 2008

(54) Method and Apparatus For Laminating Glass Panels

(75) Inventors: Jari Ala-Savikota, Tampere (FI); Tarmo Pesonen, Lempaala (FI)

Correspondence Address: BUCHANAN, INGERSOLL & ROONEY PC, POST OFFICE BOX 1404, ALEXANDRIA, VA, 22313-1404, US

(73) Assignee: TAMGLASS LTD. OY, Tampere (FI)

(21) Appl. No.: 11/667,294

(22) PCT Filed: Nov. 4, 2005
(86) PCT No.: PCT/FI05/50394

§ 371 Date: Nov. 13, 2007

(30) Foreign Application Priority Data
Nov. 9, 2004 (FI) 20045428

(51) Int. Cl. C03C 27/00; B29C 65/00

(52) U.S. Cl. 156/99; 156/538

(57) ABSTRACT

A method and apparatus for laminating glass panels in which a sandwich structure to be laminated is preheated by radiation heat (7, 8), whereafter the sandwich structure is heated by bilateral hot air blasting concurrently with radiation heating. Convection heating elements for blasting hot air include conveyor rolls (3), which are hollow and apertured. Radiation heating elements (11, 12) apply heat to the sandwich structure by direction radiation heating and additionally warm up convection air circulated in the heating chamber.

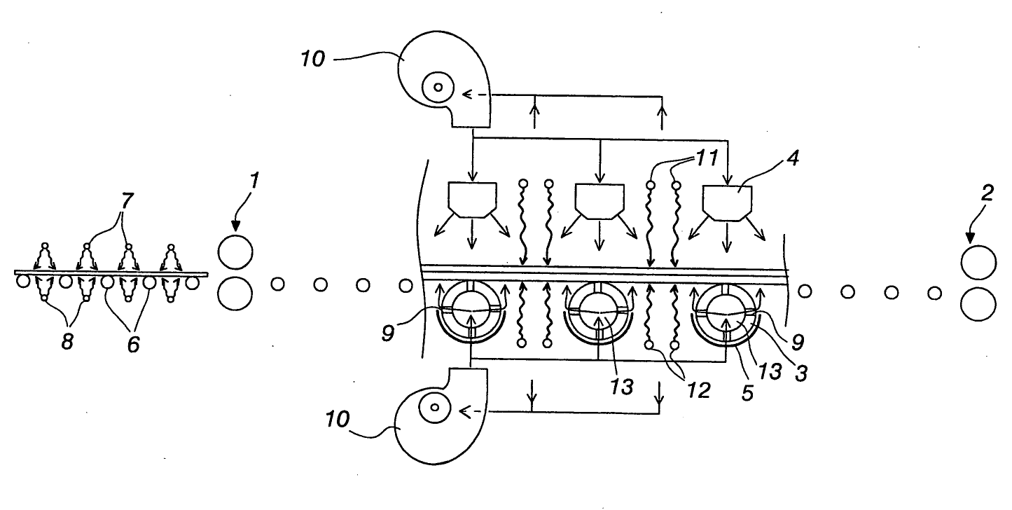

The invention relates to a method for laminating glass panels, said method comprising placing a plastic sheet between glass panels and passing a resulting sandwich structure through a first set of press rolls, followed by heating the sandwich structure and passing the heated sandwich structure through a second set of press rolls, the sandwich structure being heated between compressions by means of a bilateral blast of hot air.

The invention relates also to an apparatus for laminating glass panels, said apparatus comprising a first set of press rolls, a second set of press rolls, a horizontal conveyor between the sets of press rolls, as well as heating elements for heating a sandwich structure formed by glass panels and a plastic sheet, said heating elements, which are located between the sets of press rolls, comprising convection heating elements for blasting hot air to both sides of the sandwich structure to be laminated.

This type of method and apparatus are known from the Applicant's patent U.S. Pat. No. 5,853,516. It has proved high useful. It is an object of the invention to improve and enhance a heating effect in the actual heating process for enabling an increase of production capacity and a high-speed heating of varying thickness sandwich structures, including occasions in which the uppermost glass has its top surface coated for providing a LOW-E feature.

This object is accomplished by a method as defined in the appended claim 1 and, respectively, by an apparatus as defined in the appended claim 3.

The use of radiation heating, which penetrates deeper into a sandwich structure, enables the application of hotter-than-before convection air. In addition, bottom-side radiation heating with direct radiation will be enabled by using the rolls for passing convection air to the bottom surface of the sandwich structure.

The invention will now be described in more detail by way of an exemplary embodiment with reference to the accompanying drawing, which shows in a schematic side view an apparatus for executing the method.

In a laminating room, which has not been shown, glass panels to be laminated have been placed on top of each other with a plastic sheet therebetween. The layers are loose on top of each other and arrive substantially at room temperature upon a conveyor constituted by rolls 6. Above and below the conveyor 6 are radiation heating elements, such as tubular resistances 7, 8 for the preheating of a sandwich structure to be laminated. The sandwich structure is preheated with radiation heat for example to the temperature of about 30° C.-45° C., whereby the sheet plasticizes sufficiently for establishing as perfect a contact as possible between the glass and sheet surfaces in press rolls 1, said contact remaining intact also downstream of the compression.

From between the press rolls 1 the sandwich structure proceeds onto a conveyor constituted by rolls 3, above which are nozzle boxes 4 for blasting warm air to the top side of the sandwich structure. The heating section has its air circulated constantly through the nozzle boxes 4 by means of a fan 10 which forces air into the nozzle boxes 4, the air discharging therefrom in jets coming through nozzle rows to the top side of the sandwich structure. The fan 10 is used for aspirating air into the heating chamber, which warms up while passing by heating resistances 11. The heating resistances 11, which are e.g. tubular resistances, apply heat to the top surface of the sandwich structure also by way of direct radiation heating, which is why the heating resistances 11 are located in line with openings between the nozzle boxes 4.

The bottom-side blast of hot air is directed at least partly through voids 13. Thus, the intermediate spaces between the rolls remain clear. In line with these intermediate spaces are mounted heating resistances 12, e.g. tubular resistances, which apply heat to the bottom side of the sandwich structure also by way of direct radiation heating.

Hot air coming from the fan 10 can be guided into a void 13 of the rolls 3 by way of rotating connections present at the heads of the rolls 3. Alternatively, the rolls 3 may their apertured gable portions rotating in a compression air cabinet. Below the rolls 3 is a shroud or spout 5, positioned at an appropriate distance from the roll's 3 surface for providing an air guide channel between the shroud 5 and the roll 3 for deflecting the air discharging from the roll's apertures 9 principally up and towards the bottom surface of the sandwich structure. The shroud or spout 5 can be located alternatively inside the roll 3 for restricting or blocking a downward flow and deflecting air upwards. The heating air circulated in the heating chamber has its temperature typically within the range of 160°-180°. A combination of convection and radiation can be used for raising the temperature of the sandwich structure (glass and sheet) to the temperature range of about 60° C.-85° C., which is required for bringing the sheets to an adhesive state. The heated sandwich structure is passed through press rolls 2, thus providing an adequate bonding between glasses and sheets. The thus laminated glass is still subjected to a conventional further treatment in an autoclave.

The inventive method and apparatus are capable of achieving an improved heating rate, in addition to which the heat flow coming from both sides of the sandwich structure can be balanced also when dealing with LOW-E glasses.

1. A method for laminating glass panels, said method comprising placing a plastic sheet between glass panels and passing a resulting sandwich structure through a first set of press rolls, followed by heating the sandwich structure and passing the heated sandwich structure through a second set of press rolls, the sandwich structure being heated between compressions by means of a bilateral blast of hot air, wherein the bottom-side blast of hot air is guided at least partly through voids in conveyor rolls and said blast of hot air is supplemented by radiation heating.

2. A method as set forth in claim 1, wherein the radiation heaters are used both for the direct radiation heating of a sandwich structure to be laminated and for the heating of air circulated for hot blasting.

3. An apparatus for laminating glass panels, said apparatus comprising a first set of press rolls, a second set of press rolls, a horizontal conveyor between the sets of press rolls, as well as heating elements for heating a sandwich structure formed by glass panels and a plastic sheet, said heating elements, which are located between the sets of press rolls, comprising convection heating elements for blasting hot air to both sides of the sandwich structure to be laminated, wherein the convection heating elements include rolls of the conveyor, which are hollow and apertured for blasting air to the bottom surface of the sandwich structure to be laminated, and the apparatus comprises not only convection heating elements but also radiation heating elements on either side of the sandwich structure to be laminated.

4. An apparatus as set forth in claim 3, wherein below the apertured roll is a shroud or spout positioned for providing an air guide channel between the shroud and roll for deflecting the air discharging from the roll's apertures mainly upwards.

5. An apparatus as set forth in claim 3, wherein inside the apertured roll is a shroud or spout for restricting or blocking a downward flow and deflecting air upwards.
